(19) United States
(12) Patent Application Publication
(10) Pub. No.: US 2025/0300331 A1
(43) Pub. Date: Sep. 25, 2025

(54) SECONDARY BATTERY

(71) Applicant: SAMSUNG SDI CO., LTD., Yongin-si (KR)

(72) Inventors: Cheol Hee HWANG, Yongin-si (KR); Dong Hyun KIM, Yongin-si (KR)

(21) Appl. No.: 18/785,217

(22) Filed: Jul. 26, 2024

(30) Foreign Application Priority Data
Mar. 25, 2024 (KR) 10-2024-0040116

(51) Int. Cl. H01M 50/553; H01M 10/0525; H01M 10/0585; H01M 50/176; H01M 50/533; H01M 50/548

(52) U.S. Cl. CPC H01M 50/553; H01M 10/0525; H01M 10/0585; H01M 50/176; H01M 50/533; H01M 50/548; H01M 2220/20

(57) ABSTRACT

A secondary battery is provided that reduces welding resistance between an electrode tab and a terminal and quickly and easily dissipates heat if a plurality of electrode assembles are installed in one case. The secondary battery includes a plurality of electrode assemblies including a negative electrode plate provided with a negative electrode non-coating portion and a positive electrode plate provided with a positive electrode non-coating portion, a case accommodating the electrode assembly, a cap plate covering an open inlet of the case, a negative electrode terminal installed on the cap plate for each of the electrode assemblies and electrically connected to the negative electrode non-coating portion, and a positive electrode terminal installed in the case in an opposite direction of the negative electrode terminal and electrically connected to the positive electrode non-coating portion.

### CROSS-REFERENCE TO RELATED APPLICATION

This application is based on and claims priority under 35 U.S.C. § 119 to Korean Patent Application No. 10-2024-0040116, filed on Mar. 25, 2024, in the Korean Intellectual Property Office, the disclosure of which is incorporated by reference herein in its entirety.

### BACKGROUND

### 1. Field

Embodiments relate to a secondary battery.

### 2. Description of the Related Art

Unlike a primary battery that cannot be recharged, a secondary battery is a battery that can be recharged and discharged. A low-capacity secondary battery may be used for portable small-sized electronic devices, such as smartphones, feature phones, notebook computers, digital cameras, and camcorders, and a high-capacity secondary battery may be used as a power source for driving a motor and a power storage battery in hybrid vehicles or electric vehicles. The secondary battery may include an electrode assembly having a positive electrode and a negative electrode, a case accommodating the electrode assembly, an electrode terminal connected to the electrode assembly, and the like.

The above-described information disclosed in the technology that serves as the background of the present disclosure is only for improving understanding of the background of the present disclosure and thus may include information that does not constitute the related art.

### SUMMARY

Aspects of some embodiments of the present disclosure provide a secondary battery that reduces welding resistance between an electrode tab and a terminal and quickly and easily dissipates heat when a plurality of electrode assembles are installed in one case.

These and other aspects and features of the present disclosure will be described in or will be apparent from the following description of embodiments of the present disclosure.

According to some embodiments, a secondary battery includes: a plurality of electrode assemblies, each of the electrode assemblies including a negative electrode plate provided with a negative electrode non-coating portion and a positive electrode plate provided with a positive electrode non-coating portion; a case configured to accommodating the electrode assemblies; a cap plate covering an open inlet of the case; a negative electrode terminal installed on the cap plate for each of the electrode assemblies, each negative electrode terminal electrically connected to the negative electrode non-coating portion of one of the electrode assemblies; and a positive electrode terminal installed in the case in an opposite direction from the negative electrode terminal, the positive electrode terminal electrically connected to the positive electrode non-coating portions of the electrode assemblies.

In some embodiments, the number of positive electrode non-coating portions may be greater than the number of negative electrode non-coating portions.

In some embodiments, the electrode assembly may be provided as a stack type electrode assembly in which the positive electrode plate, a separator, and the negative electrode plate are alternately stacked.

In some embodiments, the electrode assembly may include: a first electrode assembly in which a first negative electrode non-coating portion protruding upward is disposed at a first side in a width direction of the first electrode assemblies; and a second electrode assembly which is installed with the first electrode assembly and in which a second negative electrode non-coating portion is disposed at a second side in the width direction of the electrode assemblies.

In some embodiments, the first electrode assembly may include a positive electrode non-coating portions protruding to a lower side of the first electrode assembly, with at least one of the positive electrode non-coating portions being disposed at each of both sides of the first electrode assembly in the width direction.

In some embodiments, the second electrode assembly may include a second positive electrode non-coating portions protruding to a lower side of the second electrode assembly and disposed at each of both sides of the second electrode assembly in the width direction.

In some embodiments, the positive electrode terminal may include: a positive electrode current collector plate electrically connected to the first positive electrode non-coating portions and the second positive electrode non-coating portions; a positive electrode rivet electrically connected to the positive electrode current collector plate and extending to outside of the cap plate; and a positive electrode terminal cover disposed outside the case and connected to the positive electrode rivet, with the positive electrode terminal being configured to receive current from the positive electrode rivet.

In some embodiments, the negative electrode terminal may include: a first negative electrode terminal disposed at a first side of the cap plate in a width direction of the cap plate and electrically connected to the first negative electrode non-coating portion; and a second negative electrode terminal disposed at a second side of the cap plate in the width direction of the cap plate and electrically connected to the second negative electrode non-coating portion.

In some embodiments, the first negative electrode terminal may include: a first current collector plate electrically connected to the first negative electrode non-coating portion; a first rivet electrically connected to the first current collector plate and extending to the outside of the cap plate; and a first terminal cover disposed outside the cap plate and connected to the first rivet, with the first terminal cover being configured to receive current from the rivet.

In some embodiments, the second negative electrode terminal may include: a second current collector plate electrically connected to the second negative electrode non-coating portion; a second rivet electrically connected to the second current collector plate and extending to the outside of the cap plate; and a second terminal cover disposed outside the cap plate and connected to the second rivet, with the second terminal cover being configured to receive current from the second rivet.

In some embodiments, a number of positive electrode non-coating portions may be twice as large as a number of negative electrode non-coating portions.

According to some embodiments, a secondary battery includes: an electrode assembly in which a negative electrode plate provided with a negative electrode non-coating portion, a positive electrode plate provided with a positive electrode non-coating portion, and a separator are stacked in a plate shape; a housing accommodating the electrode assembly; a plurality of negative electrode terminals installed at a first side of the housing; and at least one positive electrode terminal installed in the housing at a second side of the housing and opposite to the negative electrode terminal, a number of the at least one positive electrode terminal may be less than a number of the negative electrode terminals.

In some embodiments, a plurality of the electrode assembly may be provided, and the electrode assemblies may be stacked inside the housing and directly connected to the at least one positive electrode terminal and the negative electrode terminals.

In some embodiments, the housing may include: a case accommodating the electrode assembly therein; and a cap plate covering an open inlet of the case.

In some embodiments, each of the electrode assemblies may include: a first electrode assembly in which a first negative electrode non-coating portion protruding upward is disposed at a first side in a width direction of the electrode assemblies; and a second electrode assembly which is installed with the first electrode assembly and in which a second negative electrode non-coating portion is disposed at a second side of the housing in the width direction of the electrode assemblies.

In some embodiments, the first electrode assembly may include first positive electrode non-coating portions protruding to a lower side of the first electrode assembly, with at least one of the first positive electrode non-coating portions disposed at both sides of the first electrode assembly in the width direction of the electrode assemblies.

In some embodiments, the second electrode assembly may include second positive electrode non-coating portions protruding to a lower side of the second electrode assembly, with at least one of the second positive electrode non-coating portions disposed at sides of the second electrode assembly in the width direction of the electrode assemblies.

In some embodiments, the first negative electrode non-coating portion and the second negative electrode non-coating portion may be installed to be misaligned in a diagonal direction.

In some embodiments, the positive electrode terminal may be directly connected to the positive electrode non-coating portion.

In some embodiments, the negative electrode terminal may be directly connected to the negative electrode non-coating portion.

In some embodiments, the positive electrode plate may use at least one of LCO, NCM, NCA, LFP, or NMx as a positive electrode active material.

In some embodiments, the negative electrode plate may use a material prepared by mixing graphite and Si as a negative electrode active material.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view of an exemplary secondary battery according to embodiments;

FIG. 2 illustrates an exploded perspective view of the exemplary secondary battery according to embodiments;

FIG. 3 illustrates a cross-sectional view of the exemplary secondary battery according to embodiments;

FIG. 4 illustrates an exploded perspective view of an exemplary electrode assembly according to embodiments;

FIG. 5 illustrates a perspective view of an exemplary first electrode assembly according to embodiments;

FIG. 6 illustrates a front view of the exemplary first electrode assembly according to embodiments;

FIG. 7 illustrates a perspective view of an exemplary first positive electrode

plate, an exemplary first negative electrode, and an exemplary first separator according to embodiments;

FIGS. 8a and 8b illustrate perspective views of a battery pack including the exemplary secondary battery according to embodiments; and

FIGS. 9a and 9b illustrate perspective and side views of a vehicle including the exemplary battery pack according to embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

In addition, the terms “comprise” or “include” and/or “comprising” or “including,” when used in this specification, specify the presence of stated shapes, numbers, steps, operations, members, elements, and/or groups thereof, but do not preclude the presence or addition of one or more other shapes, numbers, steps, operations, members, elements, and/or groups thereof.

Additionally, for the purpose of facilitating an understanding of the disclosure, the attached drawings are not depicted to actual scale; dimensions of some components may be exaggerated for clarity. Also, identical components in different embodiments may be denoted with the same reference numerals.

When two objects of comparison are referred to as being the same, it means the two objects are “substantially the same.” Thus, substantially the same may include a deviation that is considered low in the art, for example, a deviation of less than 5%. In addition, when a parameter is said to be uniform in a certain region, it may mean that the parameter is uniform from an average perspective.

Although “first,” “second,” and the like are used to describe various components, these components are of course not limited by these terms. These terms are only used to distinguish one component from other components, and unless otherwise stated, a first component could be termed a second component.

Throughout the specification, unless specifically stated otherwise, each component may be singular or plural.

When an arbitrary element is referred to as being “disposed above (or below)” or “disposed on (or under)” a component, it may mean not only that the arbitrary element is disposed in contact with an upper surface (or lower surface) of the component, but also that other elements may be interposed between the component and the arbitrary element disposed on (or under) the component.

When a component is described as being “connected,” “coupled,” or “joined” to another component within this patent document, it is understood that the components may be directly connected or joined to each other. However, it should also be interpreted that an intervening component may be interposed between them, or that each component may be “connected,” “coupled,” or “joined” through another intermediary component. Furthermore, when one part is described as being electrically connected (electrically coupled) to another, this encompasses not only a direct connection but also includes scenarios where other elements are positioned in between, facilitating an indirect connection.

Throughout this specification, the term “A and/or B” should be interpreted as meaning either A, B, or both A and B, unless an alternative interpretation is explicitly stated. Thus, “and/or” encompasses any and all possible combinations of the items listed. Similarly, when “C to D” is mentioned, it is understood to mean C or more, up to and including D, unless noted otherwise. The terminology employed herein is intended solely for describing specific embodiments and should not be regarded as limiting the scope of this disclosure.

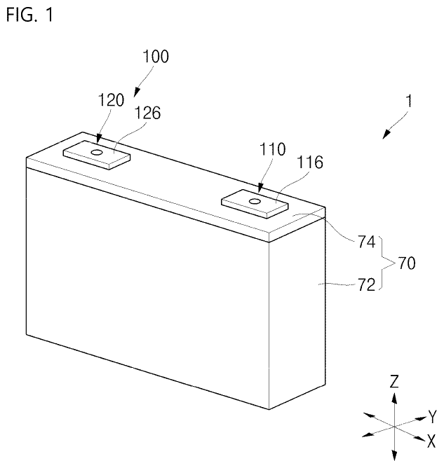

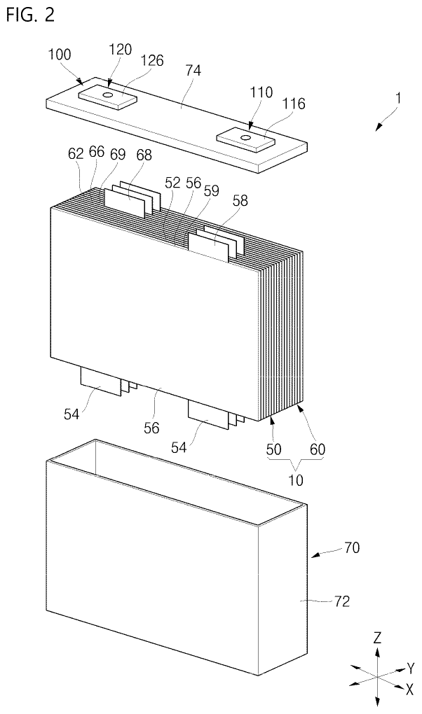

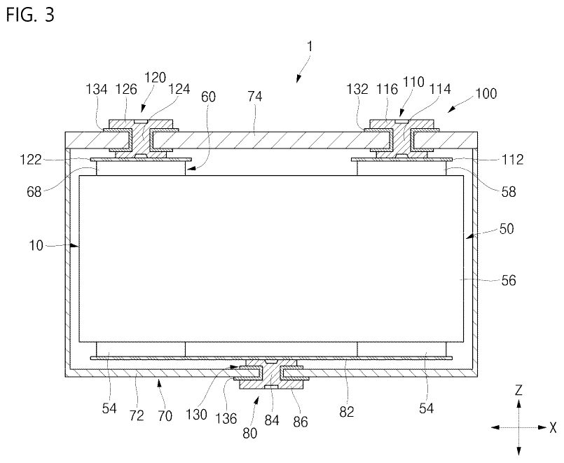

FIG. 1 illustrates a perspective view of an exemplary secondary battery 1 according to embodiments, FIG. 2 illustrates an exploded perspective view of the exemplary secondary battery 1 according to embodiments, and FIG. 3 illustrates a cross-sectional view of the exemplary secondary battery 1 according to embodiments. As illustrated in FIGS. 1 to 3, the secondary battery 1 may include an electrode assembly 10.

In the present disclosure, the secondary battery 1 may be referred to as a prismatic secondary battery 1 or a battery. A first electrode plate may be referred to as a negative electrode plate, a first negative electrode plate 56, and a second negative electrode plate 66. A second electrode plate may be referred to as a positive electrode plate, a first positive electrode plate 52, and a second positive electrode plate 62.

The electrode assembly 10 may be provided by winding or stacking a stack of a first electrode plate, a separator, and a second electrode plate, each of which is provided in a thin plate or film shape. If the electrode assembly 10 is a stack, a winding axis may be parallel to a width direction x of a case 72. In some embodiments, the electrode assembly 10 may be a stack type rather than a winding type, but the shape of the electrode assembly 10 is not limited in the present disclosure. In some embodiments, the electrode assembly 10 may include a Z-stack electrode assembly 10 in which a positive electrode plate and a negative electrode plate are inserted into both sides of the separator that is bent in the form of a Z-stack. In some embodiments, the electrode assembly 10 may be stacked so that one or more electrode assemblies 10 are adjacent to each other and accommodated in the case 72. In some embodiments, the number of electrode assemblies 10 is limited. In some embodiments, the first electrode plate of the electrode assembly 10 may serve as a negative electrode, and the second electrode plate may serve as a positive electrode. In other embodiments, the first electrode plate may serve as a negative electrode, and the second electrode plate may serve as a positive electrode.

The first electrode plate may be formed by applying a first electrode active material such as graphite or carbon to a first electrode current collector plate made of a metal foil such as copper, a copper alloy, nickel, or a nickel alloy. The first electrode plate may include a first electrode tab (or first non-coating portion) that is not coated with the first electrode active material. The first electrode tab may serve as a path for current flow between the first electrode plate and a first current collector. In some embodiments, the first electrode tab may be provided by being cut to protrude to a first side of the electrode assembly when the first electrode plate is manufactured. In other embodiments, the first electrode tab may protrude more to the first side than a separator without separate cutting.

The second electrode plate may be provided by applying a second electrode active material such as transition metal oxide to a second electrode current collector plate made of metal foil such as aluminum or an aluminum alloy. The second electrode plate may include a second electrode tab (or second non-coating portion) that is not coated with the second electrode active material. The second electrode tab may be a passage through which current flows between the second electrode plate and a second current collector. In some embodiments, the second electrode tab may be provided by being cut to protrude to a second side of the electrode assembly when the second electrode plate is manufactured. In other embodiments may protrude more to the second side than the separator without separate cutting.

In some embodiments, the first electrode tab may be disposed on a side surface of a left end of the electrode assembly 10, the second electrode tab may be disposed on a side surface of a right end of the electrode assembly 10, or the first and second electrode tabs may disposed on one surface in the same direction. Here, left and right sides are for convenience of explanation based on the secondary battery 1 illustrated in FIG. 1 and may be changed in position if the secondary battery 1 rotates left and right or upward and downward.

A first electrode tab of the first electrode plate and a second electrode tab of the second electrode plate may be disposed on both ends of the electrode assembly 10 in a vertical direction Z or width direction X as described above. In some embodiments, the electrode assembly 10 may be accommodated in the case 72 together with the electrolyte. In the electrode assembly 10, a negative electrode terminal 100 and a positive electrode terminal 80 may be welded and connected to the first electrode tab of the first electrode plate and the second electrode tab of the second electrode plate, which are exposed to both sides, respectively.

In the present disclosure, a negative electrode non-coating portion may be referred to as a first electrode tab, a negative electrode tab, a first negative electrode non-coating portion 58, a second negative electrode non-coating portion 68, or a first non-coating portion. A positive electrode non-coating portion may be referred to as a second electrode tab, a positive electrode tab, a first positive electrode non-coating portion 54, a second positive electrode non-coating portion 64, or a second non-coating portion.

In the secondary battery 1 according to embodiments, a plurality of electrode assembles 10 having a stack structure may be stacked, and the electrode assembly 10, a positive electrode terminal 80, and a negative electrode terminal 100 may be directly connected to each other. In some embodiments, in the state in which the plurality of electrode assemblies 10 having the stack structure are stacked, only one positive or negative electrode of the electrode assembly 10 may be connected to a terminal in a direct connection structure. The fact that the positive electrode of the electrode assembly 10 is directly connected to the positive electrode terminal 80 may mean that the electrode assembly 10 is in direct contact with the positive electrode terminal 80 and is fixed by welding so as to be electrically connected.

The secondary battery 1 according to embodiments may include the electrode assembly 10, a housing 70, the positive electrode terminal 80, and the negative electrode terminal 100. In some embodiments, the secondary battery 1 may further include an insulating gasket 130.

The electrode assembly 10 may have a stack structure, and the plurality of electrode assemblies 10 may be stacked to overlap each other. The plurality of electrode assemblies 10 may be modified in various manners, such as being stacked in a vertical direction Z or in a longitudinal direction Y. In some embodiments, two electrode assemblies 10 may be provided and may be disposed to be continuous in the longitudinal direction Y.

To achieve high capacity of the lithium secondary battery 1, a high-capacity battery may be implemented by using a plurality of electrode assemblies 10. A shape of the electrode assembly 10 used to manufacture the high-capacity battery may have a winding type structure or a stack type structure.

The electrode assembly 10 used in the conventional secondary battery 1 has a winding structure and a stack structure. The electrode assembly 10 having the winding structure may increase the capacity of the cell by increasing in number of turns of the electrode. However, as the number of turns of the electrode increases, there may be a risk of occurrence of cracks of the electrode plate in a round portion of the electrode assembly 10.

The electrode assembly 10 having the stack type structure may increase the capacity of the cell by increasing in number of stacked electrodes. However, as the number of electrodes stacked on the stacked electrode assembly 10 increases, the number of electrode tabs may increase. As the number of electrode tabs increases, there may be a limitation that welding is not properly performed between the electrode tab and the current collector, and the electrode assembly 10 having the stack type structure may be limited in capacity.

For these reasons, there may be limits to cell capacity using a single electrode assembly 10. In the present disclosure, several electrode assembles 10 may be used to increase the capacity of the cell.

In the related art, in the case of the cell having two or four electrode assemblies 10, with the positive electrode non-coating portion and the negative electrode non-coating portion being disposed only in one direction, there may be a limit in width of a welding part of the electrode plate to limit cell resistance and cell heat dissipation characteristics. In the present disclosure, because the lithium secondary battery 1 is constituted by two stack type electrode assembles 10, a lithium secondary battery 1 having increased energy density is secured, and cell heat dissipation characteristics are improved.

The electrode assembly 10 may be accommodated together with the electrolyte inside the casing 72. The electrode assembly 10 may include or be referred to as an electrode group, an electrode body, or a jelly roll. The electrode assembly 10 may include a positive electrode plate, a negative electrode plate, and a separator between the positive electrode plate and the negative electrode plate. The electrode assembly 10 may be modified in various manners, such as being wound in a cylindrical type or stacked in a stack type. The electrode assembly 10 may include a negative electrode plate having a negative electrode non-coating portion and a positive electrode plate having a positive electrode non-coating portion. A plurality of the electrode assembly 10 may be provided and accommodated inside the case 72. The electrode assembly 10 may be provided as a stack type electrode assembly 10 in which the positive electrode plate, the separator, and the negative electrode plate are alternately stacked. In the stack type electrode assembly 10, the negative electrode plate having the negative electrode non-coating portion, the positive electrode plate including the positive electrode non-coating portion, and the separator may be stacked in a plate shape. In some embodiments, the plurality of electrode assemblies 10 may be stacked inside the housing 70 and may be directly connected to the positive electrode terminal 80 and the negative electrode terminal 100.

In embodiments of the present disclosure, the electrode assembly 10 may include a first electrode assembly 50 and a second electrode assembly 60. The first electrode assembly 50 may include a first positive electrode plate 52, a first negative electrode plate 56, and a first separator 59. The first positive electrode non-coating portion 54 is not coated with an active material, and the first negative electrode non-coating portion 58 is not coated with the active material.

The second electrode assembly 60 may include a second positive electrode plate 62, a second negative electrode plate 66, and a second separator 69. The second positive electrode non-coating portion 64 is not coated with the active material, and the second negative electrode non-coating portion 68 is not coated with an active material.

In the present disclosure, the positive electrode plate may include or be referred to as the first positive electrode plate 52, the negative electrode plate may include or be referred to as the first negative electrode plate 56 and the second negative electrode plate 66, and the separator may include or be referred to as the first separator 59 and the second separator 69. In some embodiments, in the present disclosure, the positive electrode non-coating portion may include or be referred to as the first positive electrode non-coating portion 54 and the second positive electrode non-coating portion 64, and the negative electrode non-coating portion may include or be referred to as the first positive electrode non-coating portion 58 and the second negative electrode non-coating portion 68.

The housing 70 with the electrode assembly 10 positioned therein may be modified in various manners within the scope of the technology. For example, the housing 70 may be provided as a single member or provided by coupling a plurality of members. The housing 70 according to embodiments may include a case 72 and a cap plate 74.

The case 72 may accommodate the electrode assembly 10 and an electrolyte, and the case 72 may define an outer appearance of the secondary battery 1 together with the cap plate 74. In the present disclosure, the case 72 may include or be referred to as a case 72, a can, or an exterior. The case 72 may be modified into various shapes within the technical scope of accommodating the electrode assembly 10 and having a terminal hole at a first side thereof and an open inlet at a second side thereof.

During a process of manufacturing the secondary battery 1, an upper portion (see FIG. 2) of the case 72 may be opened. In some embodiments, during the process of manufacturing the secondary battery 1, the electrode assembly 10 may be inserted together with an electrolyte through the open upper portion of the case 72. Here, the electrolyte and the electrode assembly 10 may be inserted into the case 72 in a downward direction from the open upper portion. After the electrolyte and the electrode assembly 10 are inserted into the case 72, the cap plate 74 may be coupled to the open upper portion to seal the inside of the case 72. The case 72 may be made of steel, a steel alloy, aluminum, an aluminum alloy, or an equivalent thereof, but the material thereof is not limited in the present disclosure.

In some embodiments, lithium ions may move between a positive electrode plate and a negative electrode plate that constitute the electrode assembly 10. The electrolyte may be a non-aqueous organic electrolyte that is a mixture of lithium salt and a high-purity organic solvent. Furthermore, the electrolyte may be a polymer using a polymer electrolyte or a solid electrolyte, but the type of the electrolyte is not limited in the present disclosure.

The cap plate 74 may be modified in various manners within the technical scope of covering the open inlet of the case 72. The cap plate 74 may be coupled to an upper end of the case 72. In some embodiments, the cap plate 74 may be fixed to the case 72, and the negative electrode terminal 100 may be fixed to the cap plate 74.

The cap plate 74 may have the same polarity as the negative electrode terminal 100. In some embodiments, an insulating gasket 132 may be additionally installed between the cap plate 74 and the negative electrode terminal 100. If the insulating gasket 132 is installed on the cap plate 74, the cap plate 74 and the negative electrode terminal 100 may not be electrically connected and, thus, may not have the same polarity. If the insulating gasket 130 is installed on the cap plate 74, the cap plate 74 may be neutral.

The positive electrode terminal 80 may be modified in various manners within the technical scope of being directly connected to the positive electrode non-coating portion of the electrode assembly 10. If the negative electrode terminal 100 is installed on the cap plate 74, the positive terminal 80 may be installed on the case 72 disposed in a direction opposite to the negative electrode terminal 100. The positive terminal may be electrically connected to the positive electrode non-coating portion(s) of the electrode assembly. In some embodiments, the number of positive electrode terminals 80 may be less than that of negative electrode terminals 100. For example, the number of positive electrode terminals 80 according to embodiments may be one less than the number of negative electrode terminals 100. The number of negative electrode terminals 100 may be the same as the number of electrode assemblies 10. For example, if two electrode assemblies 10 are provided with the first electrode assembly 50 and the second electrode assembly 60, two negative electrode terminals 100 may be provided with the first negative electrode terminal 110 and the second negative electrode terminal 120. In some embodiments with two negative electrode terminals 100, there may be one positive electrode terminal 80. In some embodiments, the positive electrode terminal 80 may include a positive electrode current collector plate 82, a positive electrode rivet 84, and a positive electrode terminal cover 86.

The positive electrode current collector plate 82 may be modified in various manners within the technical scope of being electrically connected to the positive electrode non-coating portion of the electrode assembly 10 and being disposed inside the housing 70. The positive electrode current collector plate 82 may be disposed between the positive electrode rivet 84 and the positive electrode non-coating portion(s) of the electrode assembly. Because the positive electrode current collector plate 82 is welded to each of the positive electrode rivet 84 and the positive electrode non-coating portion(s), the positive electrode terminal 80 may be directly connected to the positive electrode non-coating portion(s). The positive electrode current collector plate 82 may be modified in various manners within the technical scope of being electrically connected to the first positive electrode non-coating portions 54. The first positive electrode non-coating portions 54 provided in the first electrode assembly 50 and the second positive electrode non-coating portions 64 provided in the second electrode assembly 60 may be directly connected to the positive electrode terminal 80. The positive electrode current collector plate 82 may be made of aluminum (Al).

The positive electrode rivet 84 may be modified in various manners within the technical scope of being electrically connected to the positive electrode current collector plate 82 and extending toward outside of the cap plate 74. One side of the positive electrode rivet 84 may be fixed to the positive electrode current collector plate 82 by welding, and the other side of the positive electrode rivet 84 may extend to outside of the case 72.

The positive electrode terminal cover 86 may be modified in various manners within the technical scope of being disposed outside the case 72 and being connected to the positive electrode rivet 84 to receive current. The positive electrode rivet 84 and the positive electrode terminal cover 86 may be modified in various manners such as the positive electrode rivet 84 and the positive electrode terminal cover 86 being integrated with each other, or the two members being fixed by welding or the like. Only one positive electrode terminal 80 may be installed on a bottom surface of the case 72.

In the secondary battery 1 according to embodiments, a plurality of the negative electrode terminal 100 may be provided, or only one positive electrode terminal 80 may be provided. The case 72 in which the positive electrode terminal 80 is installed may be used to accommodate various types of electrode assemblies 10. In some embodiments, the case 72 may be used to accommodate one electrode assembly 10, but the same case 72 may also be used to accommodate the plurality of electrode assemblies 10.

Because one electrode assembly 10 having the winding structure is provided with one positive electrode tab and one negative electrode tab, two or more positive electrode terminals 80 may not be connected to one positive electrode tab. Even in the case of one electrode assembly 10 having the stack structure, because only one positive electrode tab and one negative electrode tab are provided, two or more positive electrode terminals 80 may not be connected to one positive electrode tab.

The reason for not installing a plurality of positive electrode terminals 80 in the case 72 may be that the case 72 may accommodate the plurality of electrode assemblies 10, but may also accommodate only one electrode assembly 10, and being able to use the same case 72 thereby reduces production costs.

The negative electrode terminals 100 may be modified in various manners of being installed on the cap plate 74 in the same number as the electrode assembly 10 and being electrically connected to the negative electrode non-coating portion(s). The negative electrode terminal 100 may be directly connected to the negative electrode non-coating portion(s). The negative electrode terminal 100 may be installed at a first side of the housing 70, and the positive electrode terminal 80 may be installed at a second side of the housing 7 that is opposite to the first side. The negative electrode terminal 100 according to embodiments may include a first negative electrode terminal 110 and a second negative electrode terminal 120.

If two electrode assemblies 10 are provided as the first electrode assembly 50 and the second electrode assembly 60, two negative electrode terminals 100 may be installed to be provided as the first negative electrode terminal 110 and the second negative electrode terminal 120. A reason why two negative electrode terminals 100 are installed is that if only one negative electrode terminal 100 is provided, it may be difficult to achieve heat dissipation effects and cell safety may be compromised. If three negative electrode terminals 100 are provided, it may be difficult to form three or more negative electrode tabs given a size of the electrode plate of the electrode assembly 10. However, if three or more electrode assemblies 10 are installed, the negative electrode terminal 100 may also be provided in the number corresponding to the number of electrode assemblies 10.

The first negative electrode terminal 110 may be modified in various manners within the technical scope of being disposed at one side (right side in FIG. 3) in the width direction X of the cap plate 74 and being electrically connected to the first negative electrode non-coating portions 58. The first negative electrode terminal 110 according to embodiments may include a first current collector plate 112, a first rivet 114, and a first terminal cover 116.

The first current collector plate 112 may be modified in various manners within the technical scope of being electrically connected to the first negative electrode non-coating portions 58. The first current collector plate 112 according to embodiments may have a plate shape and be installed between the first rivet 114 and the first negative electrode non-coating portions 58. A lower side of the first current collector plate 112 may be welded to the first negative electrode non-coating portions 58, and an upper side of the first current collector plate 112 may be welded to the first rivet 114.

The first rivet 114 may be modified in various manners within the technical scope of being electrically connected to the first current collector plate 112 and extending toward outside of the cap plate 74. The first rivet 114 may be installed in the vertical direction Z and be installed in a shape passing through the cap plate 74. A lower side of the first rivet 114 may be welded to the first current collector 112, and an upper side of the first rivet 114 may be connected to the first terminal cover 116.

The first terminal cover 116 may be modified in various manners within the technical scope of being disposed at outside of the cap plate 74 and being connected to the first rivet 114 to receive current. The current of the first negative electrode non-coating portions 58 may sequentially flow through the first current collector plate 112 and the first rivet 114 and then be transmitted to the first terminal cover 116.

The second negative electrode terminal 120 may be modified in various manners within the technical scope of being disposed at the other side (left side in FIG. 3) in the width direction X of the cap plate 74 and being electrically connected to the first negative electrode non-coating portions 68.

The second negative electrode terminal 120 according to embodiments may include a second current collector plate 122, a second rivet 124, and a second terminal cover 126. A structure of the second negative electrode terminal 120 may be the same or similar to that of the first negative electrode terminal 110.

The second current collector plate 122 may be modified in various manners within the technical scope of being electrically connected to the second negative electrode non-coating portions 68. The second current collector plate 122 according to embodiments may have a plate shape and be installed between the second rivet 124 and the second negative electrode non-coating portions 68. A lower side of the second current collector plate 122 may be welded to the second negative electrode non-coating portions 68, and an upper side of the second current collector plate 122 may be welded to the second rivet 124.

The second rivet 124 may be modified in various manners within the technical scope of being electrically connected to the second current collector plate 122 and extending toward outside of the cap plate 74. The second rivet 124 may be installed in the vertical direction Z and be installed in a shape passing through the cap plate 74. A lower side of the second rivet 124 may be welded to the second current collector 122, and an upper side of the second rivet 124 may be connected to the second terminal cover 126.

The second terminal cover 126 may be modified in various manners within the technical scope of being disposed outside the cap plate 74 and being connected to the second rivet 124 to receive current. The current of the second negative electrode non-coating portions 68 may sequentially flow through the second current collector plate 122 and the second rivet 124 and then be transmitted to the second terminal cover 126.

The insulating gasket 130 may be installed between the positive electrode terminal 80, the negative electrode terminals 100 and 120 and the housing 70. The insulating gasket may be made of a resin material such as polyethylene (PE), polypropylene (PP), polyethylene terephthalate (PET), or the like. The insulating gasket 130 according to embodiments may include a first gasket 132, a second gasket 134, and a positive electrode gasket 136.

Because the first gasket 132 is installed between the first negative electrode terminal 110 and the cap plate 74, electrical connection between the first negative electrode terminal 110 and the cap plate 74 may be blocked. The first gasket 132 may be made of an insulating material and have elasticity. Because the second gasket 134 is installed between the second negative electrode terminal 120 and the cap plate 74, electrical connection between the second negative electrode terminal 120 and the cap plate 74 may be blocked. The second gasket 134 may be made of an insulating material and have elasticity. Because the positive electrode gasket 136 is installed between the case 72 and the positive electrode terminal 80, electrical connection between the positive electrode terminal 80 and the case 72 may be blocked. The positive electrode gasket 136 may be made of an insulating material and have elasticity. The positive gasket 136 may block contact between the case 72 and the positive electrode terminal 80 to electrically separate the case 72 from the positive electrode terminal 80.

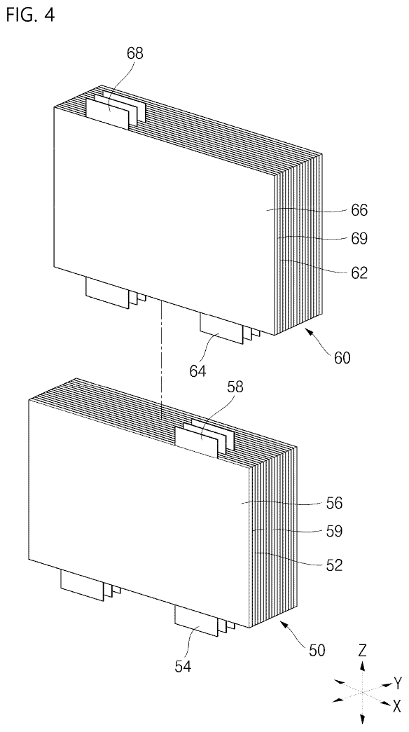

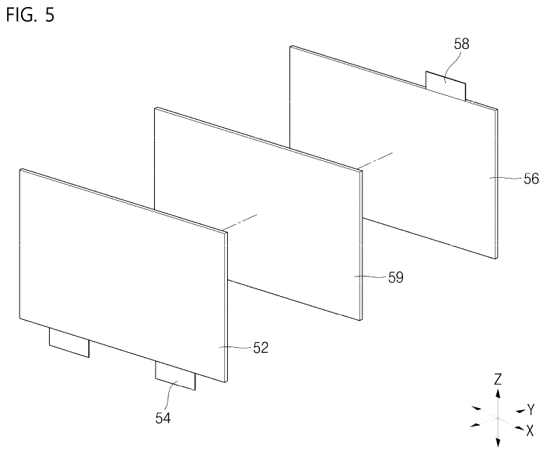

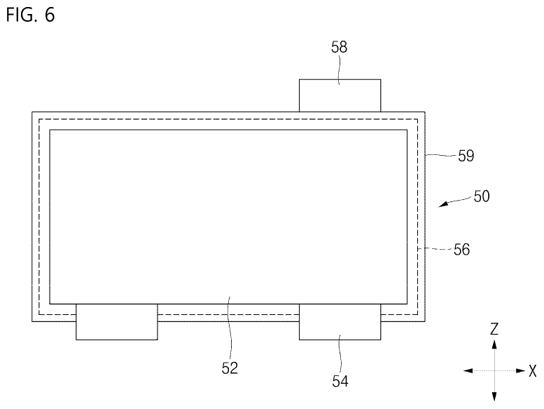

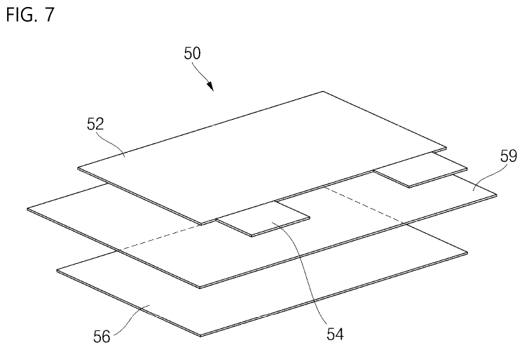

FIG. 4 illustrates an exploded perspective view of the exemplary electrode assembly 10 according to embodiments, FIG. 5 illustrates a perspective view of the exemplary first electrode assembly 50 according to embodiments, FIG. 6 illustrates a front view of the exemplary first electrode assembly 50 according to embodiments, and FIG. 7 illustrates a perspective view of the exemplary first positive electrode plate 52, the exemplary first negative electrode 56, and the exemplary first separator 59 according to embodiments. As illustrated in FIGS. 4 to 7, the electrode assembly 10 may include a first electrode assembly 50 and a second electrode assembly 60.

The first electrode assembly 50 may include a first positive electrode plate 52 provided with a first positive electrode non-coating portion 54, a first negative electrode plate 56 provided with a first negative electrode non-coating portion 58, and a first separator 59. The first negative electrode non-coating portion 58 protruding upward from the first electrode assembly 50 may be disposed at one side (right side in FIG. 4) of the first electrode assembly 50 in the width direction X.

The first positive electrode plate 52 may include a first positive electrode base material and a positive electrode active material layer disposed outside the first positive electrode base material. In the first positive electrode plate 52, the first positive electrode non-coating portion 54 on which the positive electrode active material layer is not disposed may extend to the outside (e.g., lower side) of the first positive electrode plate 52, and the first positive electrode non-coating portion 54 may be electrically connected to the positive electrode current collector plate 82. The first positive electrode plate 52 may use, for example, at least one of lithium cobalt oxide (LCO), lithium nickel cobalt manganese oxide (NCM), lithium nickel cobalt aluminum oxide (NCA), lithium iron phosphite (LFP), or nickel manganese (NMx) as the positive electrode active material.

The first positive electrode non-coating portion 54 may protrude downward from the first electrode assembly 50 and be disposed on each of both sides of the first electrode assembly 50 in the width direction X. In some embodiments, the number of positive electrode non-coating portions may be twice as large as the number of negative electrode non-coating portions. According to embodiments, one first positive electrode plate 52 may be provided with two first positive electrode non-coating portions 54. If only one first positive electrode non-coating portion 54, which is a positive electrode tab, is provided on the first positive electrode plate 52, a portion that is not welded may occur due to the structure of the stack type electrode assembly. If three first positive electrode non-coating portions 54, which are positive electrode tabs, are provided on the first positive electrode plate 52, there may be a limitation that welding has be performed three times, which reduces productivity in manufacturing. In some embodiments, two first positive electrode non-coating portions 54 may be installed on one first positive electrode plate 52. The first positive electrode non-coating portion 54 may have a rectangular projection shape, and two first positive electrode non-coating portions may protrude to a lower side (in FIG. 5) of the first positive electrode plate 52. The first positive electrode non-coating portions 54 may be disposed on both sides of the width direction X and be spaced apart from each other.

The first negative electrode plate 56 may include a first negative electrode base material and a negative electrode active material layer disposed outside the first negative electrode base material. In the first negative electrode plate 56, the first negative electrode non-coating portion 58 on which the negative electrode active material layer is not disposed may extend to outside of the first negative electrode plate 56 (for example, an upper side in FIG. 5), and the first negative electrode non-coating portion 58 may be electrically connected to the first current collector plate 112.

The first positive electrode plate 52 may be made of, for example, aluminum foil, and the positive electrode active material layer may include, for example, transition metal oxide. The first negative electrode plate 56 may be made of, for example, copper foil or nickel foil, and the negative electrode active material layer may include, for example, graphite and/or silicon. The negative electrode plate including the first negative electrode plate 56 and the second negative electrode plate 66 may use a material prepared by mixing graphite and silicon (Si) as the negative electrode active material.

The first electrode assembly 50 and the second electrode assembly 60 may be continuous in a lateral direction, and the first negative electrode non-coating portion 58 and the second negative electrode non-coating portion 68 may be installed in a diagonal direction. In some embodiments, the first negative electrode non-coating portion 58 may be directly connected to the first negative electrode terminal 110, and the second negative electrode non-coating portion 68 may be directly connected to the second negative electrode terminal 120. In the case in which two first negative electrode non-coating portions 58 and two second negative electrode non-coating portions 68, which are provided in the first electrode assembly 50 and the second electrode assembly 60 and are stacked in the stack type, a distance between the negative electrode non-coating portion 58 and the second negative electrode non-coating portion 68 may be narrowed, and the two first negative electrode non-coating portions 58 and the two second negative electrode non-coating portions 68 may be installed to overlap each other. In some embodiments, if two or more negative electrode non-coating portions are installed on the negative electrode plate, the negative electrode non-coating portions may be welded in parallel, and, thus, there may be no reason to form two negative electrode terminals 100 outside the housing 70.

The secondary battery 1 according to embodiments may be provided with two electrode assemblies 10 therein. Thus, a high-capacity secondary battery 1 may be provided by a configuration of the two electrode assemblies 10. In some embodiments, because the negative electrodes of the two electrode assemblies 10 are independently welded to the two negative electrode terminals 100, the same effect as if the two electrode assemblies 10 operate separately may be achieved. To have the same effect as if the two electrode assemblies 10 operate separately, the negative electrode non-coating portions, which are the negative electrode tabs, may be stacked in a state in which the negative electrode non-coating portions are disposed only one of one side or the other side in the width direction X. In some embodiments, the first negative electrode non-coating portions 58 and the second negative electrode non-coating portions 68 provided in the adjacent electrode assemblies 10 may be disposed in the diagonal direction (see FIG. 2).

When welding two electrode assemblies 10 that are stacked, it is possible that defects occurring during the welding process may increase. To reduce the welding defects, the electrode assemblies 10 may be disposed in a direction opposite to the protruding directions of the positive electrode non-coating portions and the negative electrode non-coating portions. For example, the positive electrode non-coating portions may protrude downward, and the negative electrode non-coating portions may protrude upward. In some embodiments, because the first negative electrode non-coating portions 58 and the second negative electrode non-coating portions 68, which constitute the negative electrode non-coating portion, may be disposed in the diagonal direction, the welding may be performed more easily and welding resistance may be reduced. In some embodiments, the increase in thickness of the electrode assembly 10 may be disadvantageous in terms of heat dissipation, but the heat dissipation characteristics of the secondary battery 1 may also be obtained by dividing the structure of the positive electrode non-coating portions and the negative electrode non-coating portions.

The first separators 59 may prevent short circuit between the first positive electrode plates 52 and the first negative electrode plates 56 from occurring while allowing movement of lithium ions. In some embodiments, the first separators 59 may be disposed on surfaces facing the first positive electrode plates 52 and/or be disposed on surfaces of the first negative electrode plates 56.

The second electrode assembly 60 may be installed to be continuous to the first electrode assembly 50, and the second negative electrode non-coating portions 68 protruding upward may be disposed at the other side (left side in FIG. 4) in the width direction X. The structure of the second electrode assembly 60 may be similar or the same as that of the first electrode assembly 50, and only the positions of the first negative electrode non-coating portions 58 and the second negative electrode non-coating portions 68 may be different. The second electrode assembly 60 according to embodiments may include second positive electrode plates 62, second negative electrode plates 66, and second separators 69.

The second positive electrode non-coating portions 64 provided on the second positive electrode plates 62 may protrude downward from the second electrode assembly 60 and be disposed at both sides of the second electrode assembly 60 in the width direction X. In some embodiments, the number of positive electrode non-coating portions may be greater than the number of negative electrode non-coating portions. In some embodiments, the number of first positive electrode non-coating portions 54 may be greater than the number of first negative electrode non-coating portions 58. In some embodiments, the number of second positive electrode non-coating portions 64 may be greater than the number of second negative electrode non-coating portions 68.

The second negative plates 66 may be stacked in a shape facing the second positive plates 62 with the second separators 69 therebetween. The first negative electrode non-coating portions 58 and the second negative electrode non-coating portions 68 may be installed alternately in the diagonal direction.

The first negative electrode non-coating portions 58 and the second negative electrode non-coating portion s68 may have a structure in which the first negative electrode non-coating portions 58 and the second negative electrode non-coating portion s68 are disposed at opposite sides of a diagonal line. In some embodiments, the first negative electrode non-coating portions 58 may be directly welded to the first negative electrode terminal 110, and the second negative electrode non-coating portions 68 may be directly welded to the second negative electrode terminal 120 to reduce the welding resistance and quickly dissipate heat of the secondary battery 1, thereby improving the safety of the secondary battery 1.

Because the secondary battery 1 is provided with the first electrode assembly 50 and the second electrode assembly 60, which are stacked, the energy density of the lithium secondary battery 1 may increase.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0≤α≤2); LiₐNi_{1-b-c}Mn_{b}X_{c}O_{2-α}D_{α}(0.90≤a≤1.8, 0≤b≤0.5, 0≤c≤0.5, 0≤a≤2); LiₐNi_{b}Co_{c}L¹_{d}GeO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0≤x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector.

The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included. As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth) acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The battery according to the above-described embodiments may be used to manufacture a battery pack.

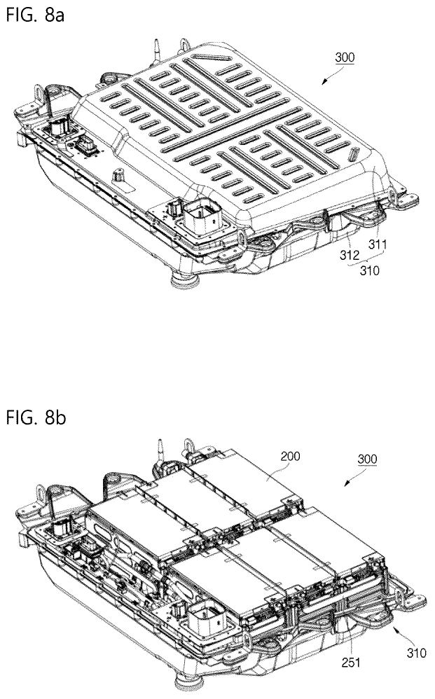

FIGS. 8a and 8b illustrate perspective views of a battery pack including the exemplary secondary battery 1 according to embodiments.

Referring to FIGS. 8a and 8b, the battery pack 300 may include a plurality of

battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

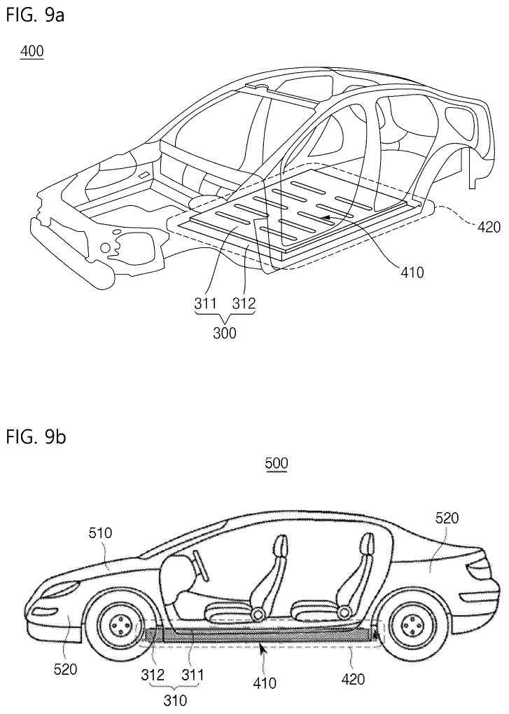

FIGS. 9a and 9b illustrate perspective and side views of vehicles 400 and 500 including the exemplary battery pack 300 according to embodiments. In FIG. 9a, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 9b, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

According to the embodiments, because the negative electrode non-coating portions provided in the two electrode assembles are welded to the two negative electrode terminals, the welding resistance may be reduced, and the heat may be quickly and easily dissipated to improve the safety of the secondary battery.

According to the embodiments, because the plurality of stack type electrode assemblies are installed inside the one case, the secondary battery may have improved in energy density.

However, the effects achievable through the present disclosure are not limited to those described above, and other technical effects not mentioned can be clearly understood by those skilled in the art from the description of the disclosure provided above.

As described above, while the embodiments of the present disclosure have been described with reference to the specific embodiments, it will be apparent to those skilled in the art that various changes and modifications may be made without departing from the spirit and scope of the disclosure.

What is claimed is:

1. A secondary battery comprising:
a plurality of electrode assemblies, each of the electrode assemblies comprising a negative electrode plate having a negative electrode non-coating portion and a positive electrode plate having a positive electrode non-coating portion;
a case accommodating the electrode assemblies, the case an open inlet;
a cap plate covering the open inlet of the case;
a negative electrode terminal installed on the cap plate for each of the electrode assemblies, each negative electrode terminal electrically connected to the negative electrode non-coating portion of one of the electrode assemblies; and
a positive electrode terminal installed in the case in an opposite direction from the negative electrode terminal, the positive electrode terminal electrically connected to the positive electrode non-coating portions of the electrode assemblies,
wherein a number of positive electrode non-coating portions is greater than a number of negative electrode non-coating portions.

2. The secondary battery as claimed in claim 1, wherein the electrode assemblies are each provided as a stack-type electrode assembly in which the positive electrode plate, a separator, and the negative electrode plate are alternately stacked.

3. The secondary battery as claimed in claim 2, wherein the electrode assemblies comprises:
a first electrode assembly in which a first negative electrode non-coating portion protruding upward is disposed at a first side in a width direction of the first electrode assemblies; and
a second electrode assembly installed with the first electrode assembly and in which a second negative electrode non-coating portion protruding upward is disposed at the other side in the width direction of the electrode assemblies.

4. The secondary battery as claimed in claim 3, wherein the first electrode assembly comprises positive electrode non-coating portions protruding downward, with at least one of the positive electrode non-coating portions being disposed at both sides of the first electrode assembly in the width direction.

5. The secondary battery as claimed in claim 4, wherein the positive electrode non-coating portions are first positive electrode non-coating portions, and
wherein the second electrode assembly comprises second positive electrode non-coating portions protruding to a lower side of the second electrode assembly and disposed at both sides of the second electrode assembly in the width direction.

6. The secondary battery as claimed in claim 5, wherein the positive electrode terminal comprises:
a positive electrode current collector plate electrically connected to the first positive electrode non-coating portions and the second positive electrode non-coating portions;
a positive electrode rivet electrically connected to the positive electrode current collector plate and extending to outside of the cap plate; and
a positive electrode terminal cover disposed outside the case and connected to the positive electrode rivet, with the positive electrode terminal being configured to receive current from the positive electrode rivet.

7. The secondary battery as claimed in claim 3, wherein the negative electrode terminal comprises:
a first negative electrode terminal disposed at a first side of the cap plate in a width direction of the cap plate and electrically connected to the first negative electrode non-coating portion; and
a second negative electrode terminal disposed at a second side of the cap plate in the width direction of the cap plate and electrically connected to the second negative electrode non-coating portion.

8. The secondary battery as claimed in claim 7, wherein the first negative electrode terminal comprises:
a current collector plate electrically connected to the first negative electrode non-coating portion;
a rivet electrically connected to the current collector plate and extending to the outside of the cap plate; and
a terminal cover disposed outside the cap plate and connected to the rivet, with the terminal cover being configured to receive current from the rivet.

9. The secondary battery as claimed in claim 7, wherein the current collector plate is a first current collector plate, the rivet is a first rivet, and the terminal cover is a first terminal cover, and
wherein the second negative electrode terminal comprises:
a second current collector plate electrically connected to the second negative electrode non-coating portion;
a second rivet electrically connected to the second current collector plate and extending to the outside of the cap plate; and
a second terminal cover disposed outside the cap plate and connected to the second rivet, the second terminal cover being configured to receive current from the second rivet.

10. The secondary battery as claimed in claim 1, wherein a number of positive electrode non-coating portions is twice as large as a number of negative electrode non-coating portions.

11. A secondary battery comprising:
an electrode assembly in which a negative electrode plate provided with a negative electrode non-coating portion, a positive electrode plate provided with a positive electrode non-coating portion, and a separator are stacked in a plate shape;
a housing accommodating the electrode assembly;
a plurality of negative electrode terminals installed at a first side of the housing; and
at least one positive electrode terminal installed at a second side of the housing at a position opposite to the negative electrode terminal,
wherein a number of the at least one positive electrode terminal is less than a number of negative electrode terminals, and
wherein a plurality of the electrode assembly is provided, and the electrode assemblies are stacked inside the housing and directly connected to the at least one positive electrode terminal and the negative electrode terminals.

12. The secondary battery as claimed in claim 11, wherein the housing comprises:
a case accommodating the electrode assembly therein; and
a cap plate configured covering an open inlet of the case.

13. The secondary battery as claimed in claim 11, wherein each of the electrode assemblies comprises:
a first electrode assembly in which a first negative electrode non-coating portion protruding upward is disposed at a first side in a width direction of the electrode assemblies; and
a second electrode assembly which is installed with the first electrode assembly and in which a second negative electrode non-coating portion is disposed at a second side in a width direction of the electrode assemblies.

14. The secondary battery as claimed in claim 13, wherein the first electrode assembly comprises positive electrode non-coating portions protruding to a lower side of the first electrode assembly, with at least one of the positive electrode non-coating portions disposed at both sides of the first electrode assembly in the width direction of the first electrode assemblies.

15. The secondary battery as claimed in claim 13, wherein the second electrode assembly comprises positive electrode non-coating portions protruding to a lower side of the second electrode assembly, with at least one of the positive electrode non-coating portions disposed at both sides of the second electrode assembly in the width direction of the electrode assemblies.

16. The secondary battery as claimed in claim 13, wherein the first negative electrode non-coating portions and the second negative electrode non-coating portions are aligned in a diagonal direction.

17. The secondary battery as claimed in claim 11, wherein the positive electrode terminal is directly connected to the positive electrode non-coating portion.

18. The secondary battery as claimed in claim 11, wherein the negative electrode terminal is directly connected to the negative electrode non-coating portion.

19. The secondary battery as claimed in claim 11, wherein the positive electrode plate uses at least one of lithium cobalt oxide (LCO), lithium nickel cobalt manganese oxide (NCM), lithium nickel cobalt aluminum oxide (NCA), lithium iron phosphite (LFP), and nickel manganese (NMx) as a positive electrode active material.

20. The secondary battery as claimed in claim 11, wherein the negative electrode plate uses a material prepared by mixing graphite and Si as a negative electrode active material.
